(19) United States
(12) Patent Application Publication
(10) Pub. No.: US 2009/0161512 A1
(43) Pub. Date: Jun. 25, 2009

(54) METHOD FOR ACCESSING DEFECT MANAGEMENT DATA

(76) Inventors: Shih-Kuo Chen, Taoyuan County (TW); Chin-Fa Hsu, Taoyuan County (TW); Shiu-Ming Chu, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/326,038

(22) Filed: Dec. 1, 2008

(30) Foreign Application Priority Data
Dec. 25, 2007 (TW) 096150418

(51) Int. Cl. G11B 20/18

(52) U.S. Cl. 369/53.17

(57) ABSTRACT

A method for accessing defect management data includes reading the required data block in an optical disc when an optical disc drive receives a command, storing data in a first buffer area, caching the required defect management data from a data cache area; otherwise, reading the required defect management data from a defect management area of the optical disc, storing the required defect management data in a second buffer area, checking if the required defect management data is hot defect management data, copying the hot defect management data to the data cache area, replacing the defect data of the first buffer area with the required defect management data, and outputting the data of the replaced first buffer area to expedite the reading process.

### BACKGROUND OF THE INVENTION

1. Field of the Invention

The invention relates to an optical disc drive, and more particularly, to an accessing method for processing and replacing defect management data stored in an optical disc when an optical disc drive reads the optical disc.

2. Description of the Prior Art

Since optical discs use tiny and concentrated marks to increase storage capacity, stains, dust or scratches can entirely cover these marks and affect the accuracy of reading. Optical disc drives provide defect management mechanisms such that data in defect areas can be stored in replacement areas on the optical disc. When an optical disc drive reads data from the optical disc, replacement data is substituted for the defect data and thus the optical disc can be read smoothly.

FIG. 1 is a diagram illustrating a conventional process of accessing defect management data of an optical disc. From an inner track to an outer track, an optical disc D is divided into a lead-in area, a replacement area 1, a data area, a replacement area 2 and a lead-out area, respectively. When an optical disc drive reads the optical disc D, a pick-up head H is first moved to a data block to be read. If a defect data block is found in the data block to be read during the data reading, the pick-up head H is moved to the replacement area 1 or replacement area 2 of a defect management area, starts reading the replacement data block, rearranges data stored in buffer areas, and then transmits disc read-back data (including the replacement data) to a host to complete the reading process of the optical disc.

FIG. 2 is a diagram illustrating a conventional method of accessing defect management data. In step P1, an optical disc drive receives a command from a host for requesting data stored in a data block. In step P2, the optical disc drive moves the pick-up head to search the location of the required data block on the optical disc, reads the data from the required data block, and stores the data in a first buffer area of a memory of the optical disc drive. Next, the flow proceeds with step P3 to move the pick-up head to the defect management area—either the replacement area 1 or replacement area 2—to search the defect management data of the required data block, read the defect management data, and store the defect management data in a second buffer area of the memory of the optical disc drive. Subsequently, in step P4, the defect management data in the second buffer area is used to replace the defect data of the data block in the first buffer area. Finally, in step P5, the optical disc drive outputs the updated data in the first buffer area to the host to complete a reading process.

However, with regards to the conventional method of accessing defect management data, each time the optical disc drive reads data of a data block, the pick-up head must be moved to the defect management area—either the replacement area 1 located in an inner track or the replacement area 2 located in an outer track—to search and read required defect management data, and then the pick-up head is moved back to the data area to read data of a data block requested by the next command. As a consequence, when the optical disc drive reads an optical disc, the pick-up head is moved back and forth between the data area and defect management area, increasing reading time and thus lowering the overall performance of the optical disc drive. Therefore, the conventional optical disc drive still has unsolved problems in accessing defect management data on an optical disc.

### SUMMARY OF THE INVENTION

One of the objectives of the present invention is to provide a method of accessing defect management data, which adds a data cache area to store hot defect management data, reads cached defect management data of the required data block, and expedites replacing data as well as correcting data of the required data block, thereby enhancing the reading efficiency.

Another objective of the present invention is to provide a method of accessing defect management data, which estimates characteristics of defect management data and sifts hot defect management data during accessing of defect management data, and stores the hot defect management data in the data cache area such that the number of times of moving a pick-up head back and forth can be reduced, thus decreasing the overall reading time.

To accomplish the aforementioned objectives, an optical disc drive receives a command to read data in the required data block on an optical disc, and stores the retrieved data in a first buffer area. The optical disc drive firstly reads cached defect management data of the required data block from a data cache area; otherwise, the optical disc drive reads defect management data of the required data block in a defect management area on the optical disc, stores the retrieved defect management data into a second buffer area, and then examines the defect management data in the second buffer area to see if the stored defect management data are hot defect management data. If the stored defect management data are hot defect management data, the optical disc drive copies the defect management data in the second buffer area to a data cache area, replaces defect data in the first buffer area with the defect management data, and outputs updated data of the required data block in the first buffer area.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional process of accessing defect management data on an optical disc.

FIG. 2 is a flowchart illustrating a conventional method of accessing defect management data.

FIG. 3 is a diagram illustrating a data structure of an optical disc.

FIG. 4 is a diagram illustrating the process of forming a data cache area according to the present invention.

FIG. 5 is a diagram illustrating the process of caching the defect management data according to the present invention.

FIG. 6 is a flowchart illustrating a method of accessing the defect management data according to the present invention.

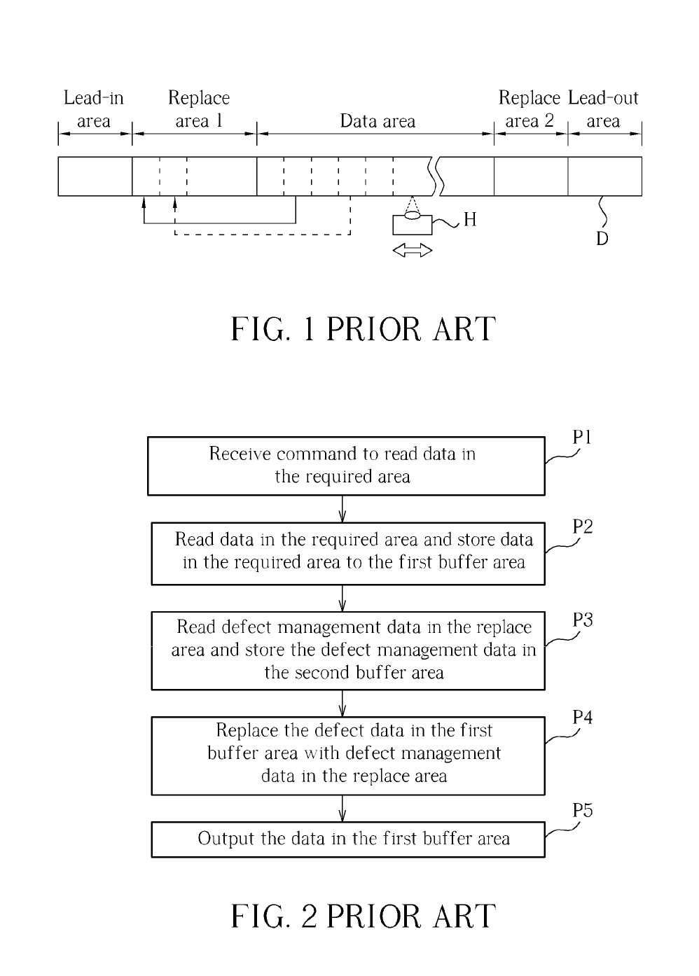

### DETAILED DESCRIPTION

To illustrate the adopted techniques and achieved benefits of the present invention, preferred embodiments along with accompanying figures are detailed as below.

When an optical disc drive reads an optical disc, the method of accessing defect management data according to the present invention firstly allocates three buffer areas, here annotated as the first buffer area, second buffer area and third buffer area, in the memory of the optical disc drive. The first buffer area is used to store obtained data of a data block, and the second buffer area is used to store obtained defect management data. Apart from original storage function of the first and second buffer areas, a separately allocated third buffer area is used as a data cache buffer area to store hot defect management data. A standard of classifying hot defect management data includes the address of defect management data, type of defect management data, and the number of times of accessing defect management data. When the optical disc drive receives a command to read data of a data block on the optical disc, during the process of accessing the defect management data, the hot extent of the defect management data is also estimated, and the defect management data qualified as hot defect management data are then stored in the third buffer area.

Since only the data in the first and second buffer areas are rewritten each time an optical disc drive reads data of a data block, data in these two buffer areas are repeatedly deleted and updated. The third buffer area is separately allocated, data read from the optical disc will not be stored in the third buffer area directly, and thus the original storage state of the third buffer area is unaffected by data reading of the data block on the optical disc. Instead, after the defect management data qualified as hot defect management data are consequently stored into the third buffer area and appended to the original data stored in the third buffer area, the data amount of the hot defect management data is increased gradually.

When an optical disc drive receives a command, the optical disc drive reads data in the required data block on the optical disc, and stores the retrieved data in the first buffer area. Next, the optical disc drive searches the third buffer area for the defect management data of the data block. If the defect management data of the required data block are found, the optical disc drive uses the cached defect management data in the third buffer area to replace the defect data in the first buffer area immediately, and then outputs the replaced data in the first buffer area. Therefore, the reading time of defect management data can be reduced greatly. If the defect management data of the required data block cannot be found in the third buffer area, the optical disc drive reads the defect management data in the defect management area on the optical disc and stores the retrieved defect management data in the second buffer area; meanwhile, the optical disc drive makes an estimation to see if the retrieved defect management data are hot or not. Those qualified as hot defect management data in the second buffer area are then copied to the third buffer area as new cached defect management data. The optical disc drive also replaces the defect data in the first buffer area by the retrieved defect management data, and outputs replaced data to complete the data reading operation.

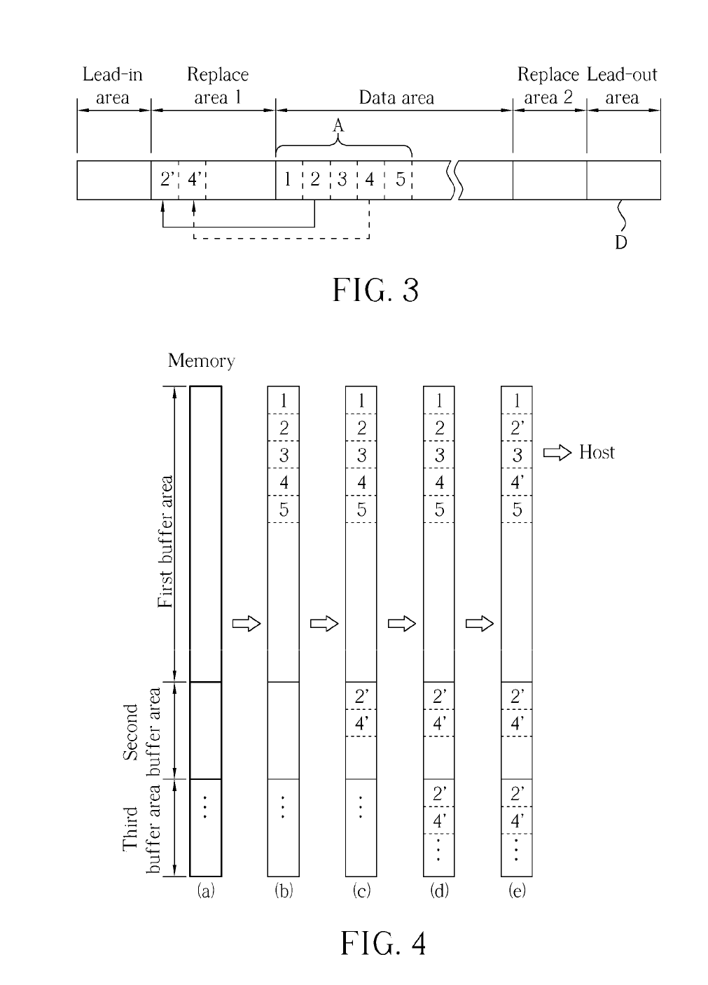

For an illustration of this process, please refer to FIG. 3 in conjunction with FIG. 4. FIG. 3 illustrates a data structure of an optical disc, and the sub-diagrams (a)-(e) in FIG. 4 represent the process of forming a data cache area according to the present invention method of accessing defect management data. As shown in FIG. 3, the data structure of the optical disc D includes a data block A within the data area, and the block A has a plurality of data clusters 1-5, where data cluster 2 and data cluster 4 contains defect data, and the corrected data (i.e., the defect management data 2′ and 4′) are stored in the replacement area 1. As demonstrated in the sub-diagram (a) in FIG. 4, when an optical disc drive receives a command from a host to read data in the data block A on an optical disc D, the optical disc drive firstly allocates three buffer area, including a first buffer area, a second buffer area and a third buffer area, in the memory of the optical disc drive. As shown in the sub-diagram (b) in FIG. 4, the optical disc drive reads data from the data block A on the optical disc D, and then stores the retrieved data clusters 1-5 in the first buffer area.

Next, as shown in the sub-diagram (c) in FIG. 4, the optical disc drive searches defect management data 2′ and 4′ of the data block A in the third buffer area; if those data cannot be found in the third buffer area, the optical disc drive then accesses the defect management area on the optical disc D by performing a data search in the replacement area 1 and replacement area 2, and stores the defect management data 2′ and 4′ of the data block A that are read from the replacement area 1 into the second buffer area. Then, the optical disc drive estimates if the retrieved defect management data 2′ and 4′ in the second buffer area are qualified as hot defect management data or not (sub-diagram (d) in FIG. 4). If the defect management data 2′ and 4′ are qualified as hot data, the optical disc drive copies the defect management data 2′ and 4′ to the third buffer area as the newly added cache data. Finally, as shown in the sub-diagram (e) in FIG. 4, the optical disc drive replaces defective data clusters 2 and 4 in the first buffer area with defect management data 2′ and 4′ respectively, and then outputs data, including original and replaced data clusters, 1, 2′, 3, 4′, 5 in the first buffer area, to complete the data reading of the data block A.

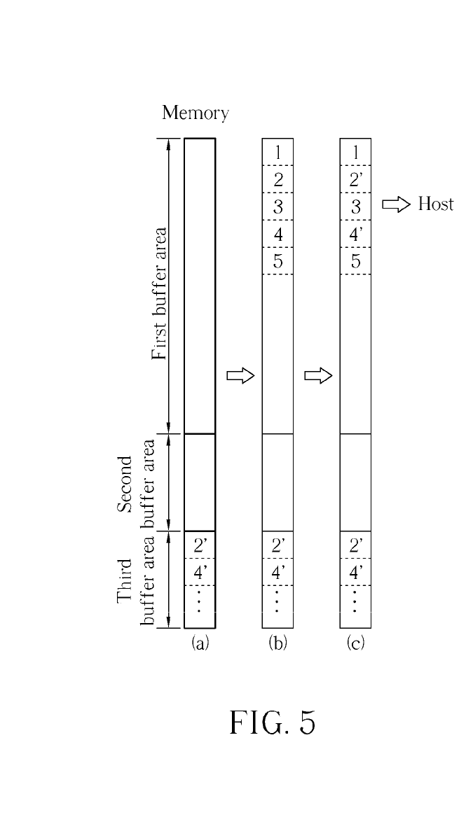

Please refer to FIG. 3 in conjunction with FIG. 5. Sub-diagrams (a)-(c) in FIG. 5 illustrate the data caching process according to the present invention method of accessing defect management data. As shown in the sub-diagram (a) in FIG. 5, when an optical disc drive reads data in the data block A on the optical disc D upon receiving a command from a host, the third buffer area among the three buffer areas within the memory of the optical disc drive still keeps cache data stored therein. Next, as shown in the sub-diagram (b) in FIG. 5, the optical disc drive reads data from the data block A on the optical disc D, and stores the retrieved data clusters 1-5 orderly in the first buffer area. Then, as shown in the sub-diagram (c) in FIG. 5, the optical disc drive firstly searches the defect management data 2′ and 4′ of the data block A in the third buffer area; if those data are found in the third buffer area, the optical disc drive replaces the defective data clusters 2 and 4 of the data block A in the first buffer area with the cached defect management data 2′ and 4′ in the third buffer area, and then outputs the data, including original and replaced data clusters 1, 2′, 3, 4′, 5 in the first buffer area, to complete the reading process of the data block A quickly.

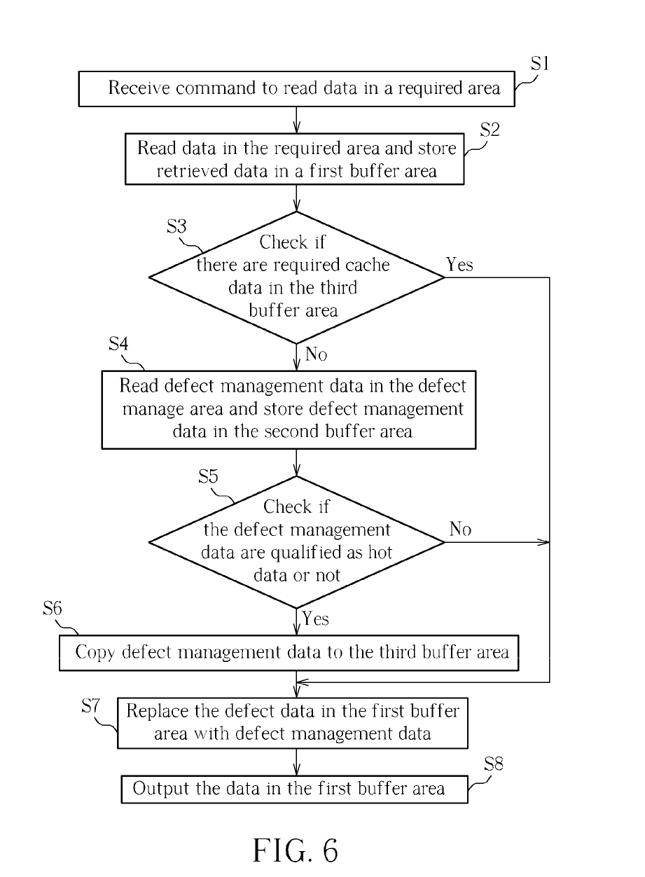

FIG. 6 is a flowchart illustrating a method of accessing defect management data according to the present invention. The present invention makes use of the third buffer area separately allocated in the memory to serve as a data cache area for hot defect management data. The detailed steps for boosting the reading speed are as follows. First, in step S1, the host instructs the optical disc drive to read data in a required data block. Next, in step S2, the optical disc drive reads data in the required data block, and stores the retrieved data in the first buffer area. Then, in step S3, the optical disc drive checks if there are defect management data of the required data block in the third buffer area. If the third buffer area has the required defect management data stored therein, then the flow proceeds with step S7 to use the defect management data cached in the third buffer area to replace the defect data in the first buffer area, thereby enabling the first buffer area to store correct data of the required data block. Next, in step S8, the optical disc drive outputs the correct data of the required data block, derived from replacing the defect data with the defect management data, to the host. In this way, reading data of the data block can be completed quickly.

If the defect management data of the required data block are not found in the third buffer area, the flow then proceeds with step S4 to search the defect management area on the optical disc for defect management data of the required data block, and then store the retrieved defect management data into the second buffer area. Next, in step S5, the optical disc drive checks if the defect management data in the second buffer area are qualified as hot defect management data. If the defect management data are not qualified as hot defect management data, the flow then proceeds with step S7 to directly replace defect data in the first buffer area with the defect management data to derive corrected data of the required data block. Next, in step S8, the optical disc drive outputs the corrected data in the first buffer area to the host to complete the data reading of the data block. If the defect management data is qualified as hot defect management data, the flow then proceeds with step S6 to copy the defect management data stored in the second buffer area to the third buffer area as cache data. Next, in step S7, the optical disc drive directly replaces defect data in the first buffer area with the defect management data to derive corrected data of the required data block. Then, in step S8, the optical disc drive outputs the corrected data in the first buffer area to the host to complete the data reading of the data block.

Based on the aforementioned steps of accessing the defect management data, the method of accessing defect management data according to the present invention is capable of estimating characteristics of defect management data and shifting hot defect management data in the course of accessing defect management data when an optical disc drive reads an optical disc. Furthermore, the method of accessing defect management data according to the present invention also allocates a third buffer area in the memory to cache hot defect management data, and thus builds a data cache area for defect management data. The data cache area is checked as first priority when searching for defect management data. In this way, the number of times of moving the pick-up head back and forth to read the defect management data on the optical disc can be reduced, and the reading time is also shortened. The objective of enhancing the reading efficiency is thereby accomplished.

Those skilled in the art will readily observe that numerous modifications and alterations of the device and method may be made while retaining the teachings of the invention.

What is claimed is:

1. A method of accessing defect management data employed by an optical disc drive to read data from an optical disc, the optical disc drive comprising a memory having a plurality of buffer areas allocated therein, the method comprising:
(1) receiving a command for reading data of a required data block on the optical disc;
(2) reading data in the required data block and storing read data into a first buffer area;
(3) reading defect management data of the required data block that are cached in a data cache area;
(4) replacing defect data in the first buffer area with the defect management data; and
(5) outputting replaced data of the data block in the first buffer area.

2. The method of claim 1, wherein step (3) comprises:
checking if the data cache area has the defect management data of the required data block stored therein;
when the data cache area has the defect management data of the required data block stored therein, reading the defect management data of the required data block cached in the data cache area, and then proceeding with step (4); and
when the defect management data of the required area are not found in the data cache area, reading the defect management data of the required data block from a defect management area on the optical disc, and then proceeding with step (4).

3. The method of claim 2, wherein after reading the defect management data of the required data block from the defect management area on the optical disc, the method further comprises:
(3-1) storing the defect management data of the required data block read from the defect management area on the optical disc into a second buffer area.

4. The method of claim 3, wherein after step (3-1) is executed, the method further comprises:
(3-2) checking if the defect management data in the second buffer area are hot defect management data or not; when the defect management data in the second buffer area are hot defect management data, copying the defect management data in the second buffer area to the data cache area; and when the defect management data in the second buffer area are not hot defect management data, proceeding with step (4) directly.

5. The method of claim 4, wherein a standard of classifying hot defect management data includes a number of times of accessing defect management data, a location of defect management data, or a type of defect management data.

6. The method of claim 4, wherein the hot defect management data stored in the data cache area are appended to data stored in the data cache area such that hot defect management data are accumulated in the data cache area.
